(19) United States
(12) Patent Application Publication
(10) Pub. No.: US 2020/0062403 A1
(43) Pub. Date: Feb. 27, 2020

(54) PASSENGER SEATING ARRANGEMENT WITH SHARED ACCESS

(71) Applicant: ACUMEN DESIGN ASSOCIATES LIMITED, London (GB)

(72) Inventor: Andrew Stephen Fereday WILLIAMS, London (GB)

(73) Assignee: Acumen Design Assoociates Limited, London (GB)

(21) Appl. No.: 16/344,627

(22) PCT Filed: Oct. 26, 2017
(86) PCT No.: PCT/GB2017/053234

§ 371 Date: Apr. 24, 2019

(30) Foreign Application Priority Data
Oct. 28, 2016 (GB) 1618271.9

(51) Int. Cl. B64D 11/06

(52) U.S. Cl. CPC B64D 11/0601; B64D 11/0606; B64D 11/0605; B64D 11/0604

(57) ABSTRACT

A passenger seating arrangement is disclosed including a column of seat units, the column includes a multiplicity of pairs of seat units, each pair of seat units including an inwardly-facing seat unit and an adjacent outwardly-facing seat unit. The inwardly- and outwardly-facing seat units are angled at an acute angle to the longitudinal axis of the aircraft. Each seat unit is configurable between a seating configuration and a flat-bed configuration. The passenger seating arrangement further includes a plurality of entrance ways, each entrance way being located between a neighbouring pair of seat units, and each entrance way being a shared entrance way to provide access from the aisle to two seat units, the two seat units being an inwardly-facing seat unit of one pair and the neighbouring outwardly-facing seat unit of the neighbouring pair.

### TECHNICAL FIELD

The present invention relates to an aircraft passenger seating arrangement, and to pairs of seat units for use in an aircraft passenger seating arrangement.

### BACKGROUND OF THE INVENTION

Aircraft passenger seating arrangements having convertible seat units that have both a seat configuration, and a flat-bed configuration are well-known. These convertible seat units are typically provided in business class or first class cabins of an aircraft. In the seat configuration, the seat unit typically provides a relatively upright seat, whereas in the bed configuration, the seat unit tends to form a substantially planar sleeping surface for supporting the passenger. The seat units shown in GB2326824 (British Airways), WO03013903 (Virgin Atlantic) and U.S. Pat. No. 7,178,871 (British Airways) are examples of such convertible seat units (often referred to as having ‘lie-flat’ seats) that have both a seat configuration, and a flat-bed configuration which offers improved comfort over a reclined seat. Lie-flat seats have been increasingly popular over the last decade or so.

GB2326824 and WO03013903 mentioned above are examples of so-called herringbone arrangements in which the seats are at an angle to the longitudinal axis of the aircraft. By angling the seat units in such a way, the packing efficiency may be increased.

U.S. Pat. No. 7,178,871 mentioned above, and WO 2007/072045 (also British Airways) are examples of seating arrangements having pairs of seat units facing in opposite directions. Such an arrangement may be space-efficient across the width of the cabin because the seating space of one seat unit may extend over the leg space of the adjacent, oppositely facing, seat unit. However, there is an associated problem in such seat designs in that to access seat units that are not directly adjacent an aisle, it tends to be necessary for the passenger to ‘step-over’ the space of a neighbouring passenger. This can detrimentally affect the feeling of privacy and personal space for the passengers in one or both of the relevant seats.

The seat units in WO2009/073244 (BE Aerospace) face the same direction (in each column) and are arranged in parallel. However this arrangement also suffers from the problem that the window seat passenger needs to ‘step-over’ the space of a neighbouring passenger in order to get to their seat unit.

U.S. Pat. No. 8,348,195 (American Airlines) discloses a herringbone arrangement in which alternate seat units face in alternate directions. Each seat has independent access to an adjacent aisle so passengers do not have to step-over the neighbouring seat to access their own seat. This is beneficial in terms of passenger's privacy, but has been found to have an impact in terms of the packing efficiency of the seating arrangement. The arrangement in U.S. Pat. No. 8,348,195 is shown for use on a wide-body aircraft and comprises a two-column-wide array along the centre of the aircraft, bounded by aisles either side and with single-width columns against the aircraft sidewall.

WO2014049362 (Acumen Design Associates) describes an arrangement having a plurality of pairs of seat units, each pair comprising a non-aisle seat unit arranged parallel to the longitudinal axis of the aircraft, and an aisle seat unit angled thereto, so as to provide a passenger access path to the non-aisle seat unit. Such an arrangement addresses some of the above-mentioned problems, but there remains a desire to provide other space-efficient arrangements that have adequate access to each seat unit.

### SUMMARY OF THE INVENTION

According to a first aspect of the invention, there is provided a passenger seating arrangement in an aircraft cabin, the passenger seating arrangement comprising a column of seat units located adjacent an aisle, the column of seat units and the aisle both extending in a longitudinal direction parallel to the longitudinal axis of the aircraft cabin. The column comprises a multiplicity of pairs of seat units arranged consecutively along the longitudinal direction, each pair of seat units comprising an inwardly-facing seat unit and an adjacent outwardly-facing seat unit, the inwardly-facing seat unit being angled at an acute angle to the longitudinal axis of the aircraft and facing inwardly towards the aisle, and the outwardly-facing seat unit being angled at an acute angle to the longitudinal axis of the aircraft but facing outwardly away from the aisle. Each seat unit is configurable between a seating configuration and a flat-bed configuration. The passenger seating arrangement further comprises a plurality of entrance ways, each entrance way being located between a neighbouring pair of seat units, and each entrance way being a shared entrance way to provide access from the aisle to two seat units, the two seat units being an inwardly-facing seat unit of one pair and the neighbouring outwardly-facing seat unit of the neighbouring pair.

The present invention recognises that, in the context of an alternately facing herringbone arrangement (i.e. pairs of inwardly and outwardly-facing seat units), the packing efficiency of the seating arrangement can be improved by providing shared entrance ways to two seat units. For example, the floor-space that would otherwise be used for a dedicated entrance to only one of the types of seat unit (e.g. the inwardly-facing seat unit) can instead be occupied by part of the neighbouring type of seat units (e.g. part of the outwardly-facing seat unit). This ‘saved space’ may instead be occupied by, for example, part of the seat unit that forms the sleeping surface, by additional side furniture/storage or by a combination of both.

The shared entrance is preferably the only entrance to the two seat units. The two seat units are preferably not accessible from another entrance. The number of entrance ways is preferably equal to half of the number of seat units within the multiplicity of pairs of seat units.

The entrance way is preferably an obstacle free entrance way. An access path preferably extends from the shared entrance way to the seat units. The access path is preferably obstacle free. The access path is preferably a permanent access path. The pairs of seat units are preferably arranged such that the usability of the access path to access one of the seat units (e.g. the inwardly-facing seat unit of one pair), is preferably independent of whether the other seat unit (e.g. the neighbouring outwardly-facing seat unit of the neighbouring pair) is in the seat configuration or in the flat bed configuration. For example it is preferably not necessary to ‘step-over’ the outwardly-facing seat unit, in order to access the neighbouring inwardly-facing seat unit of the neighbouring pair (or vice versa). The pairs of seat units may be arranged such that the usability of the access path to access one of the seat units, is preferably independent of whether or not a passenger is occupying the other seat unit.

Each seat unit is configurable between a seating configuration and a flat-bed configuration. This type of re-configurable seat unit per se is well known in aircraft seating, especially in business class seating. Such a seat unit may sometimes be referred to as a “lie-flat seat”.

A seat unit may have a foot-receiving end. The foot receiving end is preferably configured to receive a passenger's feet when the seat unit is in the flat-bed configuration. A seat unit may comprise a head-receiving end. The head receiving end is preferably configured to receive a passenger's head when the seat unit is in the flat-bed configuration.

A seat unit may have a seat body comprising moveable seating elements arranged such that when the seat unit is in the seating configuration the seating elements form a passenger seat but when the seat unit is in the flat-bed configuration, the seating elements form a substantially flat sleeping surface. The moveable seating elements may, for example, comprise a seat pan, a seat back, and/or a footrest.

In some embodiments, the moveable seating elements may form substantially all of the sleeping surface when the seat unit is in the flat-bed configuration. In other embodiments, the moveable elements need not necessarily form all of the sleeping surface when the seat unit is in the flat-bed configuration. For example, in some embodiments of the invention, each seat unit may comprises an ancillary bed surface. In the flat bed configuration, the ancillary bed surface may form part of the sleeping surface in conjunction with the moveable seating elements. The ancillary bed surface may be fixed. The ancillary bed surface may be removeable (for example it may be created by an insert element). The ancillary bed surface may be at a height such that it is co-planar with the flat sleeping surface formed by seating elements when the seat unit is in the flat-bed configuration.

The ancillary bed surface may form an extension of the flat sleeping surface formed by seating elements when the seat unit is in the flat-bed configuration. A seat unit may comprise such an ancillary bed surface at a foot receiving end of the seat unit. Alternatively or additionally, the seat unit may comprise such an ancillary bed surface at a head receiving end of the seat unit.

In some embodiments of the invention, both the inwardly-facing seat unit and the outwardly-facing seat unit in each pair may have any or all of the above-mentioned features. However, in other embodiments of the invention, the inwardly-facing seat units in each pair may have different features and/or differently shaped features, to the outwardly-facing seat unit in each pair.

Each seat unit may comprise a central axis. The central axis preferably extends through the centre of the seat (for example it may bisect a seat pan and/or back-rest of the seat when in the seating configuration). The central axis of each seat unit is preferably fixed (for example the seat units preferably do not comprise swivel seats). The angle of the seat unit is preferably defined as the angle between the central axis and the longitudinal axis of the aircraft.

The outwardly-facing seat units may be facing one of forwards or backwards. The inwardly-facing seat units may be facing the other of forwards of backwards. It will be appreciated that the inward/outward facing of the seat units refers to their orientation relative to the aisle (i.e. whether the passenger would be facing towards or away from the aisle). In contrast, the forward/backward facing of the seat units refers to their orientation relative to the direction of travel of the aircraft (i.e. whether the passenger would be facing towards the front of the aircraft or towards the rear of the aircraft).

All the multiplicity of pairs of seat units are preferably identical. Thus, the column is preferably formed by a repeating pattern of identical pairs of seat units. The pairs of seats units are preferably adjacent one another along the longitudinal direction. Within a column, the pairs of seat units are arranged in the same orientation.

The column of seat units extends in a longitudinal direction. The lateral extent of each seat units within each pair of seat units (i.e. the width perpendicular to the longitudinal direction) is preferably equal. Thus, the seat units in each pair preferably extend to a shared, substantially linear, longitudinal boundary along the aisle.

The inwardly and outwardly-facing seat units in each pair of seat units, may border each other along a shared boundary. Each pair of seat units may comprise an intra-pair privacy screen positioned between the inwardly and outwardly-facing seat units in each pair, for providing privacy between those two seat units within each pair (for example for screening the two seat units within each pair, from each other). In some embodiments the intra-pair screen is fixed. In other embodiments, the intra-pair privacy screen may be configurable between a deployed configuration for maintaining privacy between passengers seated in pair of seat units, and a stowed configuration for enabling those passengers to interact. In the stowed configuration, the line of sight between the passengers in the pair of seat units may no longer be screened. In principle, the privacy screen may be configurable between the deployed and stowed configuration in a number of ways (for example it may be collapsible, foldable or slideably received in a base unit). It will be appreciated that in the stowed configuration, it need not be that the whole of the screen is stowed. The deployed configuration may be a raised configuration. The stowed configuration may be a lowered configuration.

Various other (optional) features of the inwardly and/or the outwardly-facing seat units are also described below. It will be appreciated that unless otherwise stated, any feature described herein with reference to one seat unit is equally applicable to the other corresponding seat units in the arrangement (for example features described with reference to one inwardly-facing seat unit, may be applicable to any of the other inwardly-facing seat units in the arrangement).

The inwardly and/or outwardly facing seat units may comprise a monitor screen (for example for in-flight entertainment (IFE)). The monitor screen may be pivotable between a stowed position and a deployed position. In the deployed position, the monitor screen is preferably arranged to facing the passenger. The pivot is preferably a vertical hinge. The pivot may be at a distal edge of the monitor screen (relative to the passenger) such that it folds out moving away from the passenger. The pivot may be located at a location along the seat unit such that the monitor screen forms a privacy screen when deployed. The width of the seat unit may taper. The pivot may be located at a location along the seat unit such that when the monitor screen is in the deployed position, it substantially spans the width of the unit. Such an arrangement may be especially beneficial in terms of providing privacy.

In some embodiments, each pair of seat units may be separated from a neighbouring pair of seat units in the column by an inter-pair privacy screen. The inter-pair privacy screen may extend only part-way between the inwardly-facing seat unit of one pair and the neighbouring outwardly-facing seat unit of the neighbouring pair, thereby leaving an opening through which a passenger may pass to access one of the seat units. By providing an inter-pair privacy screen that extends only part-way between the respective seat units (rather than completely separating the two seat units) access to both seat units (from the shared entrance way) may be enabled.

The opening is preferably accessible from the aisle via the entrance way. The opening may be located between a foot receiving end of the inwardly-facing seat unit, and the end of the inter-pair privacy screen.

An access path preferably extends from the shared entrance way to one of the seat units, via the opening. The access path may also extend from the shared entrance way to the other of the seat units (that is associated with the shared entrance way).

The inter-pair privacy screen may extend in a direction away from the sidewall of the aircraft. The inter-pair privacy screen may be configured to screen a line of sight between passengers seated in the inwardly-facing seat unit of the one pair and the neighbouring outwardly-facing seat unit of the neighbouring pair. The inter-pair privacy screen may be angled relative to the respective seat units to screen the line of sight. The height and/or length of the privacy screen may be configured to screen the line of sight.

The inter-pair privacy screen may be configurable between a deployed configuration for maintaining privacy between passengers seated in the inwardly-facing seat unit of the one pair and the neighbouring outwardly-facing seat unit of the neighbouring pair, and a stowed configuration for enabling those passengers to interact. In the stowed configuration, the line of sight may no longer be screened. In principle, the privacy screen may be configurable between the deployed and stowed configuration in a number of ways (for example it may be collapsible, foldable or slideably received in a base unit). It will be appreciated that in the stowed configuration, it need not be that the whole of the screen is stowed. The deployed configuration may be a raised configuration. The stowed configuration may be a lowered configuration.

Each seat unit may comprise a perimeter structure. At least some of the perimeter structure may form part of the perimeter structure of the pair of seat units. At least some of the perimeter structure may be coincident between the two seat units (for example along the intra-pair privacy screen). The perimeter structure may comprise a wall structure. The perimeter structure may form part of the inter-pair, and/or the intra-pair, privacy screen.

Each inwardly-facing seat unit may comprise a foot receiving end. The foot-receiving end may have a wall defining a partially enclosed space for receiving the passenger's feet. For example the wall may be an end wall dividing the seat unit from the aisle (for an inwardly facing seat unit).

The foot receiving end may comprise an ancillary bed surface. The ancillary bed surface may be coplanar with the sleeping surface when the seat unit is in the flat-bed configuration, such that the ancillary bed surface acts as a bed-extension surface. The ancillary bed surface may be fixed. The ancillary bed surface may be suitable as a foot rest when the seat unit is in a seating configuration. For example, the foot-receiving end may comprise an ottoman. In other embodiments the foot receiving end may not have any ancillary bed surface. For example, it may merely provide a wall defining the partially enclosed space for receiving the passenger's feet (for example when resting on a moveable seating surface of the seat unit) when the seat unit is in a flat-bed configuration.

The foot receiving end of each inwardly-facing seat unit may comprise an upper surface, the upper surface being located at a height greater than the height of the sleeping surface when the seat unit is in the flat-bed configuration. The upper surface may, in some embodiments, be for use by the passenger in the inwardly-facing seat unit. In some other embodiments, the upper surface may be for use by the passenger in the neighbouring outwardly-facing seat unit of the neighbouring pair of seat units.

The foot receiving end of each inwardly-facing seat unit may extend up to the aisle. The foot receiving end may, for example border the aisle.

Each outwardly-facing seat may also have a foot receiving end having one or more of the above-mentioned features. For each pair of seat units, the planform shape of the foot receiving end of the outwardly-facing seat unit may be different from the planform shape of the foot receiving end of the inwardly-facing seat unit. Embodiments of the invention recognise that the foot receiving end of the outwardly-facing seat unit is not necessarily subject to the same design constraints as the foot receiving end of the inwardly-facing seat unit. For example, the foot receiving end of the inwardly-facing seat unit may be shaped to facilitate access through the shared entrance way, whereas the foot receiving end of the outwardly-facing seat unit need to not necessarily accommodate any access space (for example if it is adjacent a sidewall of the aircraft). The foot receiving ends may be configured such that the length of the flat sleeping surface, when the seat units are in the flat bed configuration, is the same for both the inwardly-facing and the outwardly-facing seat units.

Each of the outwardly-facing seat units may comprise a rearward space for receiving the passenger's head when the seat unit is in the flat bed configuration. The rearward space may be behind the seat when the seat unit is in the seating configuration. A head-receiving end of each outwardly-facing seat unit may comprise a shroud partially defining the rearward space for receiving the passenger's head. In some embodiments, the space may be occupied by a moveable seating element (when the seat unit is in the flat bed configuration). In some embodiments, the space may be occupied by an ancillary bed surface. The ancillary bed surface may be located between the shroud and the seat body of the seat unit. The ancillary bed surface may be at a height such that it is co-planar with the flat sleeping surface formed by seating elements when the seat unit is in the flat-bed configuration. The ancillary bed surface may be fixed. The ancillary bed surface is preferably a bed extension surface configured to form part of the flat sleeping surface when the seat unit is in the flat bed configuration.

The head receiving end of the outwardly-facing seat unit in one pair of seat units, may adjoin the foot receiving end of the inwardly-facing seat unit in that pair of seat units. For example, there is preferably no access path extending between the head receiving end of the outwardly-facing seat unit and the foot receiving end of the inwardly-facing seat unit in each pair. By removing the need for a dedicated access path (by virtue of the shared entrance way), a compact seating arrangement is facilitated.

The shared entrance way is preferably defined between part of an outwardly-facing seat unit and the foot receiving end of the neighbouring inwardly-facing seat unit of the neighbouring pair of seat units. The shared entrance way may be defined between side furniture of the outwardly-facing seat unit and the foot receiving end of the neighbouring inwardly-facing seat unit of the neighbouring pair of seat units.

The inwardly and outwardly-facing seat units are arranged in an alternately-facing herringbone arrangement. Embodiments in which there is an inter-pair privacy screen extending part-way between the seat units have been found to be especially beneficial when used in conjunction with a relatively high herringbone angle (i.e. with seat units forming a relatively high acute angle to the longitudinal axis of the aircraft cabin). The acute angle at which the inwardly-facing seat unit is orientated, is preferably of substantially identical magnitude to the acute angle at which the outwardly-facing seat unit is orientated. The acute angle may be at least 35 degrees or more. The acute angle may be at least 40 degrees or more. The acute angle may be less than 50 degrees. The acute angle may be in a range between 35 and 50 degrees. The acute angle is preferably measured between the central axis of a respective seat unit and the longitudinal axis of the aircraft cabin. It will be appreciated that the angle is being measured relative to the axes in question and is measured in a consistent manner for both seat units. Thus the direction in which the angle is measured is not related to the orientation of the respective seat unit as such.

In some embodiments of the invention, each inwardly-facing seat unit is open-ended. Having open-ended inwardly-facing seat units has been found to be especially beneficial in enabling access to the two seat units via the shared entrance way. Each inwardly-facing seat unit is preferably arranged such that when the inwardly-facing seat unit is in the flat-bed configuration, a moveable seating element extends to the foot receiving end of the seat unit, but when the inwardly-facing seat unit is in the seating configuration, the moveable seating element is retracted such that there is an access space through which a passenger may pass.

The access space is such that a passenger may pass through to access the inwardly-facing seat unit. The access space is preferably accessible from the aisle via the entrance way. The access path to the inwardly-facing seat unit preferably passes from the shared entrance way to said inwardly-facing seat unit, via the access space. The access path to the outwardly-facing seat units may pass from the shared entrance way to the outwardly-facing seat unit (in some embodiments that access may also be via another opening (for example an opening created by a partially extending privacy screen as described above)).

The foot receiving end of inwardly-facing seat unit may be open-ended; thus the foot receiving end of inwardly-facing seat units may be formed from (and more preferably only from) a moveable structure (such as a moveable seating element). The foot receiving end of inwardly-facing seat unit preferably does not comprise a fixed structure. For example it may not comprise a wall for enclosing the passenger's feet. Such an arrangement ensures straightforward access via the access space when the seat is in the seating configuration. When the inwardly-facing seat unit is in the flat-bed configuration, the access space may be occupied, or even blocked, by the foot receiving end of the inwardly-facing seat unit (for example by the presence of a moveable seating element extending to the foot receiving end).

The outwardly-facing seat unit preferably still comprises a fixed structure at the foot-receiving end. The outwardly-facing seat unit is preferably close-ended. For example, the outwardly-facing seat unit may comprise an ottoman at the foot receiving end.

Embodiments in which each inwardly-facing seat unit is open-ended, have been found to be especially beneficial when used in conjunction with a relatively low herringbone angle (i.e. with seat units forming a relatively low acute angle to the longitudinal axis of the aircraft cabin). The first acute angle (at which the inwardly-facing seat unit is orientated), is preferably of substantially identical magnitude to the second acute angle (at which the outwardly-facing seat unit is orientated). The acute angle may be at least 25 degrees or more. The acute angle may be at least 28 degrees or more. However, the acute angle may be less than 35 degrees, and preferably less than 33 degrees. The acute angle may be in a range between 25 and 35 degrees.

In embodiments in which each inwardly-facing seat unit is open-ended, the inwardly-facing seat units may be remote from the aisle. For example, the inwardly-facing seat unit may be set back from the aisle. The foot receiving end is preferably set-back from the aisle. The foot receiving end of each inwardly-facing seat unit is preferably remote from the shared entrance way. The foot receiving end of the inwardly-facing seat unit in each pair may be located between (for example sandwiched directly between) the outwardly-facing seat unit of that pair, and the outwardly-facing seat unit of the neighbouring pair.

In embodiments in which the inwardly-facing seat unit is set-back from the aisle, the shared entrance way is preferably defined between the outwardly-facing seat units in neighbouring pairs of seat units.

In embodiments in which the seat units comprise moveable seating elements, the moveable seating elements may comprise a seat pan. The seat pan of each seat unit may comprise a chamfered corner. The chamfered corner may be adjacent an access path through the shared entrance way. Such an arrangement may facilitate access to one or more of the respective seat units.

In embodiments in which the seat pan is moved forwards from the seat configuration to the flat bed configuration, the chamfered corner may reduce the width of the sleeping surface towards the foot receiving end. The chamfered corner may be on the same side of each seat pan (for example on the left-hand side of each seat pan (as viewed from each seat pan), or on the right-hand side of each seat pan (as viewed from each seat pan)). Having the chamfered corner on the same side of each seat pan may be beneficial because the chamfered corners may complement each other when the seat units (i.e. the inwardly-facing seat unit of one pair and the neighbouring outwardly-facing seat unit of the neighbouring pair) are in the flat-bed configuration. For example, the narrower-width portions of the sleeping surfaces (of the inwardly-facing seat unit of one pair and the neighbouring outwardly-facing seat unit of the neighbouring pair) may tessellate.

In any of the above-mentioned embodiments, the column of seat units may be a first column of seat units. The seating arrangement may further comprise a second column of seat units located on the other side of, but adjacent to, the aisle, the second column of seat units also extending in a longitudinal direction parallel to the longitudinal axis of the aircraft cabin. The second column is preferably arranged in the same manner as the first column and any features described with reference to the first column may be applicable to the second column. For example, the second column may comprise a multiplicity of pairs of seat units arranged consecutively along the longitudinal direction, each pair of seat units comprising an inwardly-facing seat unit and an outwardly-facing seat unit, the inwardly-facing seat unit being angled at a first acute angle to the longitudinal axis of the aircraft and facing inwardly towards the aisle, and the outwardly-facing seat unit being angled at a second acute angle to the longitudinal axis of the aircraft but facing outwardly away from the aisle, wherein each seat unit is configurable between a seating configuration and a flat-bed configuration, and wherein the passenger seating arrangement further comprises a plurality of entrance ways, each entrance way being located between an adjacent pair of seat units, and each entrance way being a shared entrance way for providing access from the aisle to two seat units, the two seat units being an inwardly-facing seat unit of one pair and the neighbouring outwardly-facing seat unit of the neighbouring pair.

The passenger seating arrangement of embodiments of the present invention has been found to be especially beneficial for a single aisle aircraft because the seating arrangement tends to be space-efficient whilst still facilitating direct access to each seat unit from the aisle. Thus, the first column may be positioned adjacent a sidewall of the cabin and second column may be positioned adjacent the opposing sidewall of the cabin.

In some embodiments of the invention, the seating arrangement may nonetheless also be used on a twin aisle aircraft. Thus, the first column may be positioned adjacent a sidewall of the cabin and second column may be positioned adjacent a second aisle. The arrangement may further comprises a third column of pairs of seat units between the opposing sidewall and the second aisle. The third column may be arranged in the same manner as the first or second column and any features described with reference to the first or second column may be applicable to the third column. Thus, the cabin may be for a twin-aisle aircraft, and the seating arrangement may comprise three equal-width columns of pairs of seat units extending along the cabin. Having equal-width columns in both the centre and the sides of the cabin has been found to be more space-efficient than some arrangements having a double-width central column (e.g. U.S. Pat. No. 8,348,195).

According to another aspect of the invention, there is provided a pair of seat units for use as the pair of seat units in the first aspect of the invention. The pair of seat units may be configured to be arranged consecutively, with other corresponding pairs of seat units, in a column along a longitudinal direction, the pair of seat units comprising an inwardly-facing seat unit and an adjacent outwardly-facing seat unit, the inwardly-facing seat unit being angled at an acute angle to the longitudinal direction and facing inwardly, and the outwardly-facing seat unit being angled at an acute angle to the longitudinal direction but facing outwardly, in the opposite direction to the inwardly-facing seat unit,

wherein each seat unit is configurable between a seating configuration and a flat-bed configuration, and

wherein the pair of seats units in configured to be arranged with an entrance way located between it and a neighbouring pair of seat units, the entrance way being a shared entrance way to provide access from the aisle to two seat units, the two seat units being an inwardly-facing seat unit of one pair and the neighbouring outwardly-facing seat unit of the neighbouring pair.

According to another aspect of the invention, there is provided a passenger seating arrangement in a single aisle aircraft cabin, the passenger seating arrangement comprising a first column of lie-flat seat units located on one side of the single aisle, and a second column of lie-flat seat units located on the other side of the aisle, wherein: each column comprises a multiplicity of seat units arranged in an alternately-facing herringbone layout in which alternate seat units face inwardly and outwardly towards/away from the aisle, wherein the passenger seating arrangement further comprises a plurality of shared entrance ways, each shared entrance way having obstacle-free access from the aisle to two seat units in a respective column. All the outwardly-facing seat units may border the aisle and all the inwardly-facing seat units may be set back from the aisle. In such embodiments, the inwardly-facing seat units preferably do not have an ottoman or an end-wall such that they are open-ended to allow access to the inwardly-facing seat units from the shared entrance way.

It will be appreciated that any features described with reference to one aspect of the invention are equally applicable to any other aspect of the invention, and vice versa. For example, any features described with reference to the first aspect, may be applicable to the second or third aspects of the invention, and vice versa. It will also be appreciated that reference above to one or more features of a seat unit and/or a pair of seat units may be applicable to any or all of the other seat units and/or pairs of seats units described herein.

### DESCRIPTION OF THE DRAWINGS

Various embodiments of the invention will now be described, by way of example only, with reference to the accompanying schematic drawings of which:

FIG. 1 is a plan view of a business class cabin on an aircraft according to a first embodiment of the invention;

FIG. 2 is a close-up plan view of part of the arrangement of FIG. 1;

FIG. 3 is a perspective view of two pairs of seat units in one of the columns of the cabin of FIG. 1;

FIG. 4 is a perspective view of the two pairs of seat units of FIG. 3, but with the seat units in the flat bed configuration;

FIG. 5 is a view of the foot receiving end on an outwardly-facing seat unit, from a viewpoint within the seat unit;

FIG. 6 is a view of the foot receiving end on an inwardly-facing seat unit, from a viewpoint within the seat unit;

FIG. 7 is a perspective view of the two pairs of seat units in FIG. 3 but with the intra-pair privacy screen lowered;

FIGS. 8a and 8b are perspective views of the pairs of seat units of FIG. 3, but with the inter-pair privacy screen lowered;

FIG. 9 is a plan view of a business class cabin on an aircraft according to a second embodiment of the invention;

FIG. 10 is a plan view of a business class cabin on an aircraft according to a third embodiment of the invention;

FIG. 11 is a close-up plan view of part of the arrangement of FIG. 10;

FIG. 12 is a perspective view showing two of the pairs of seat units, both of which are in the seating configuration;

FIG. 13 is a perspective view of FIG. 12, but with the seat units in the flat bed configuration;

FIG. 14 is a perspective view part of the seat units showing the shared entrance way;

FIG. 15 is a seating layout in the front of an aircraft cabin according to a further embodiment;

FIG. 16 is a close up view of part of the layout in FIG. 15;

FIG. 17 is a view from an inwardly-facing seat unit of the layout of FIG. 15 when it is in the flat-bed configuration;

FIGS. 18a, 18b and 19 are perspective views of two neighbouring pairs of seat units in the layout of FIG. 15; and

FIGS. 20a and 20b are perspective views from the view point of an inwardly-facing seat unit in the layout of FIG. 15.

### DETAILED DESCRIPTION

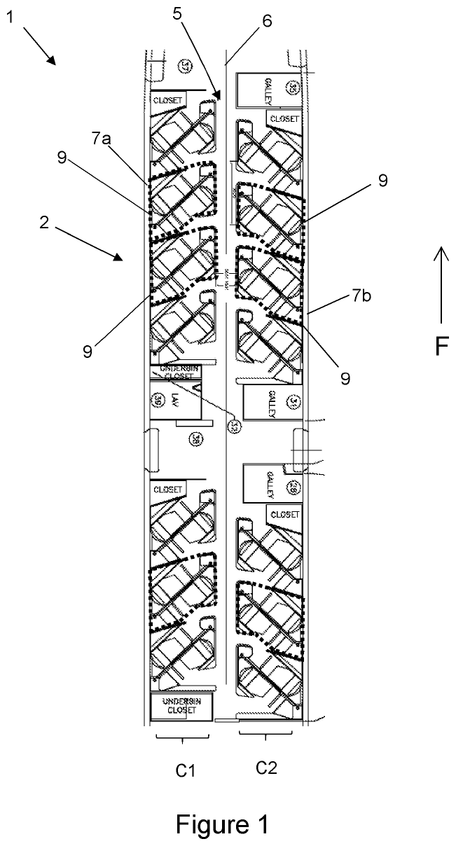

FIG. 1 is a schematic plan view of a business class cabin 2 in an aircraft of a first embodiment of the invention. The cabin 2 comprises a passenger seating arrangement 1.

The passenger seating arrangement 1 comprises a first column of seat units C1 and second column of seat units C2. The first and second columns C1, C2 are separated by an aisle 5 aligned with the longitudinal axis 6 of the cabin. As is most clearly indicated in FIG. 1, the columns of seat units C1, C2 and the aisle 5 all extend in a longitudinal direction parallel to longitudinal axis 6 of the cabin 2. The aircraft cabin is defined by sidewalls 7a, 7b. The cabin 2 comprises several non-seating areas, such as galleys and lavatories, but these are largely conventional and are not described further with reference to the present invention.

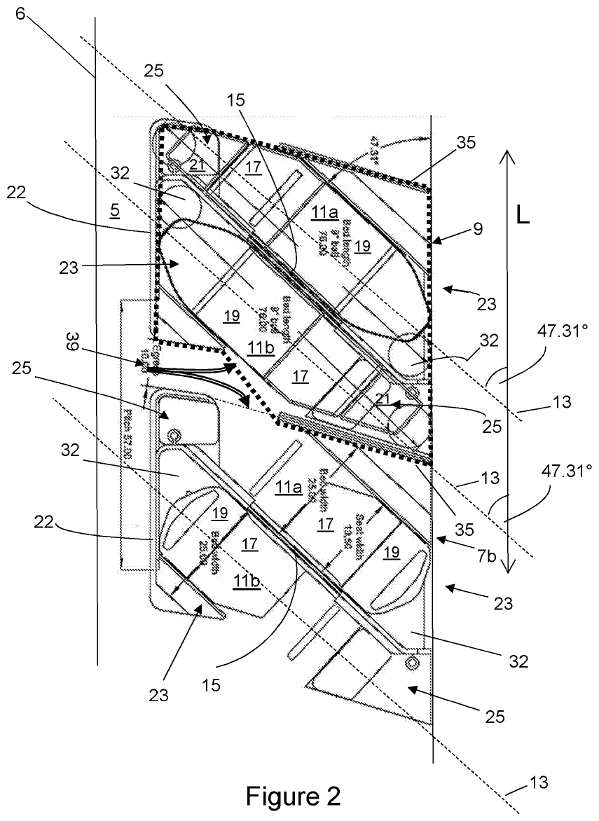

Each column C1, C2 comprises several pairs 9 of seat units (some example pairs 9 in each column are highlighted by way of a schematic thicker dashed outline in FIGS. 1 and 2). The pairs 9 of seat units in each column C1, C2 are substantially identical except for their orientation/position.

In each column C1, C2, the pairs 9 of seat units are arranged adjacent to one another along the longitudinal direction (i.e. neighbouring pairs 9 of seat units are located along the length of each column C1, C2).

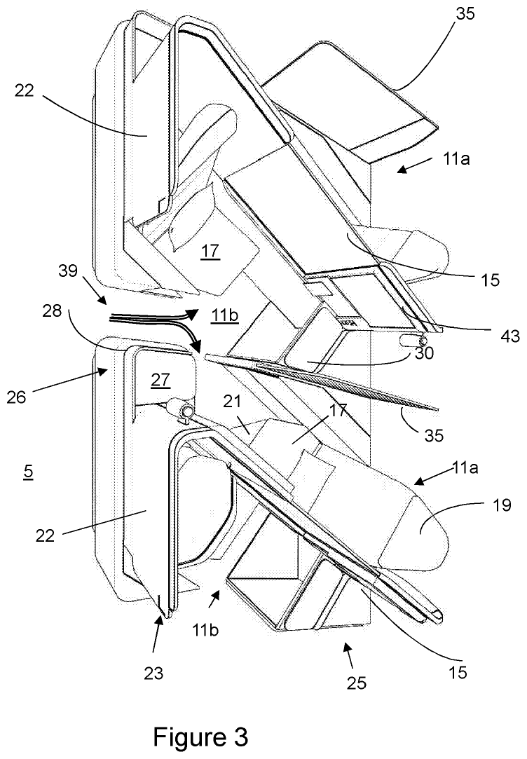

FIGS. 2 to 8b show close-up views of a few of the adjacent pairs 9 of seat units, and features of those pairs of seat units are described below in detail. The pairs of seat units in FIGS. 2 to 8b are taken from column C2 in FIG. 1. In the description below, where reference is made to only the one pair 9 of seat units, or to only one seat unit 11a, 11b within that pair, it will be appreciated that the description applies equally to other corresponding pairs 9 or other corresponding seat units 11a, 11b in the seating arrangement 1. Also, for the sake of clarity, not all reference numerals used in FIGS. 1 to 8b are necessarily repeated in the other drawings (e.g. in the others of FIGS. 1 to 8b) nor are they necessarily shown for every occurrence of that feature. The other seat units shown in FIGS. 1 to 9 do, of course, have those features but some of them are merely not labelled.

Referring now to FIG. 2, each pair 9 of seat units comprises: an inwardly-facing seat unit 11a and an outwardly-facing seat unit 11b. The inwardly-facing seat unit 11a is angled at 47.31 degrees to the longitudinal direction L (which is parallel to the longitudinal axis 6 of the cabin) and faces inwardly towards the aisle 5. The outwardly-facing seat unit 11b is angled at the same angle (47.31 degrees) to the longitudinal direction but faces outwardly away from the aisle 5.

The angle of the seat unit to the longitudinal direction is measured by the angle that the central seat unit axis 13 makes with the longitudinal direction L (and the aisle axis 6). The central axis of a seat unit is the axis that bisects the seat body of the respective seat unit 11a/11b.

In the first embodiment, the inwardly-facing seat unit 11a faces forwards (relative to the direction of flight F (see FIG. 1)), whereas the outwardly-facing seat unit faces backwards (relative to the direction of flight F).

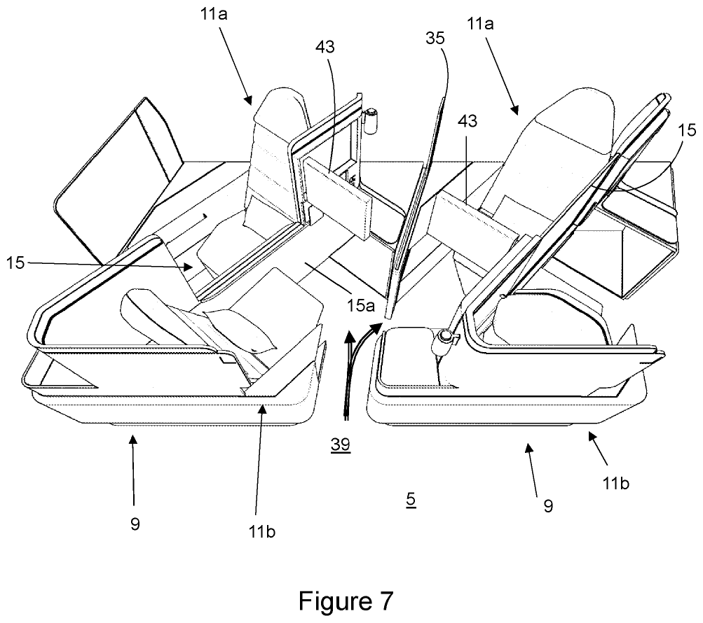

The inwardly-facing seat unit 11a and outwardly-facing seat unit 11b in each pair 9 of seat units, border each other along an intra-pair privacy screen 15 that defines a shared boundary. That boundary runs parallel to the central axis 13 of the seat units (i.e. at around 47 degrees to the longitudinal direction). The privacy screen 15 is selectively retractable such that it can be raised or lowered depending on whether passengers in the seat units wish to interact with each other (described in more detail below with respect to FIG. 7).

Each seat unit 11a, 11b comprises a seat body 23 and a foot receiving end 25.

The seat body 23 has a moveable seat pan 17, movable back rest 19 and moveable leg support 21. A shroud 22 surrounds the back rest 19 of the outwardly-facing seat units 11b, whereas the back rest 19 of the inwardly-facing seat units 11a is adjacent the aircraft sidewall 7b. The moveable seating elements 17, 19 and 21 are configurable from a seating configuration into a lie flat configuration (described in more detail below)

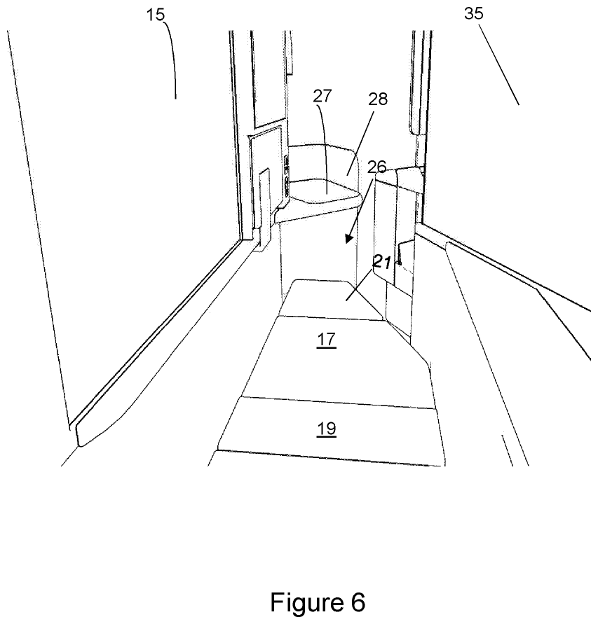

The seat bodies 23 of the inwardly and outwardly-facing seat units are substantially identical. However, the side furniture associated with each seat body, and the foot receiving end 25 of the inwardly and outwardly-facing units differ. The foot receiving end of the inwardly-facing seat units 11a is best shown in FIG. 6 (which is a view from within one of the inwardly-facing seat units 11a). On the inwardly-facing seat units 11a, the foot receiving end 25 is spaced apart from the seat body 23 and comprises an ottoman. The foot receiving end 25 has a curved end wall 26 extending from the cabin floor, a central shelf (not visible in the Figures) to form the ottoman, and a table surface 27. The end wall 26 defines a partially enclosed space into which the passenger may insert their feet (and place them of the central shelf if wanted). A divider 28 shields the table surface 27 from the passenger in the adjacent seat unit 11b (but in other embodiments the divider may equally be arranged to shield the table surface from the passenger in the inward facing seat unit such that the table surface 27 is instead accessible to the passenger in the adjacent (outwardly-facing) seat unit).

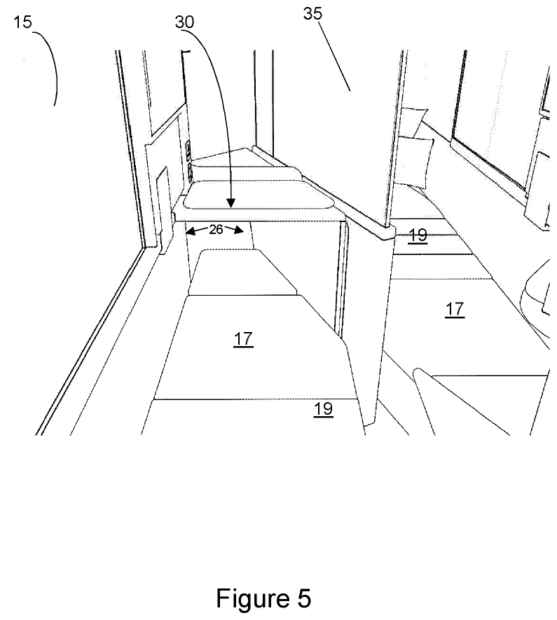

The foot receiving end 25 of the outwardly-facing seat units 11b is best shown in FIG. 5 (which is a view from within one of the outwardly-facing seat units 11b). On the outwardly-facing seat units 11b, the foot receiving end 25 does not include an ottoman. It comprises an end wall 26 (defined in part by the structure of the seat unit and defined in part by the aircraft sidewall 7a/7b) that defines a partially enclosed space into which the passenger may place their feet. The space does not include a central shelf as per the inwardly-facing seat units) but the seat unit does comprise a table surface 30 spaced apart from the seat body 23 and located at a height above the flat sleeping surface (see below). The seat body 23, when in the flat bed configuration, extends under the table surface 30 and into the space.

The foot receiving end 25 of each outwardly-facing seat unit 11b has a different planform shape (i.e. as viewed in FIGS. 1 and 2) to the foot receiving end 25 of each inwardly-facing seat unit 11a. Since the foot receiving end 25 of the outwardly-facing seat unit 11b is remote from the aisle 5, it may include, for example, a relatively large table surface 30. In contrast, the foot receiving end of the inwardly-facing seat unit tends to have, for example, a smaller table surface 28 to allow adequate access to the seat units 11a, 11b (see below).

The head-receiving end of each outwardly-facing seat unit 11b adjoins the structure of the foot receiving end 25 of the inwardly-facing seat unit in that pair 9. There is no access path between those parts of the pair of seat units, and the space is instead primarily occupied by ancillary bed extension surface 32 located behind the seat back of the outwardly-facing seat unit (see FIG. 2).

Each seat unit 11a, 11b is configurable between a seating configuration and a flat-bed configuration. In the seating configuration (shown for the lower pair of seat units in FIG. 2) the moveable elements 17, 19, 21 of the main body 23 form an upright passenger seat with the foot receiving end 25 located in front of the seat. The moveable seat pan 17, movable back rest 19 and moveable leg support 21 may, however, be configured into a flat sleeping surface (shown in the upper pair 9 in FIG. 2) such that the seat unit is in a flat-bed configuration. The flat sleeping surface is formed from the moveable seat elements 17, 19, 21 being mutually coplanar, and also being coplanar with an ancillary bed extension surface 32 located behind the seat back 19. Together, these surfaces form a useable bed length of 76 inches when the seat unit is in the flat bed configuration.

The use of moveable seat elements and conversion between a seating configuration and a lie-flat configuration is known per se and will not be described in further detail herein. The benefits enabled by embodiments of the present invention tend to instead reside in other aspects of the seat units, and their layout, as will now be described in more detail.

Firstly, the passenger seating arrangement 2 further comprises a plurality of shared entrance ways 39 located between a neighbouring pair 9 of seat units 11a, 11b. Each entrance way 39 is defined between the wall 26 of the foot receiving end 25 of the inwardly-facing sear unit 11a, and the adjacent side furniture of the (head receiving end of) the outwardly-facing seat unit 11b.

Each entrance way 39 is a shared entrance way to provide exclusive access from the aisle 5 to two seat units 11a, 11b. Those two seat units 11a, 11b are an inwardly-facing seat unit 11a of one pair 9 and the neighbouring outwardly-facing seat unit 11b of the neighbouring pair 9. An obstacle free access path, shown with large arrows in FIGS. 2 to 4, extends from the shared entrance way 39 to the seat units 11a, 11b.

The first embodiment of the invention recognises that, in the context of an alternately facing herringbone arrangement, the packing efficiency of the seating arrangement can be improved by providing shared entrance ways 39 to two seat units 11a, 11b. For example, the floor-space that would otherwise be used for a dedicated entrance to only, for example, the inwardly-facing seat unit 11b, can instead be occupied by part of the neighbouring outwardly-facing seat unit 11b. This ‘saved space’ may instead be occupied by part of the seat unit that forms the sleeping surface, by additional side furniture/storage or by a combination of both.

A feeling of privacy remains important, and accordingly between each pair of seat units 9 is an inter-pair privacy screen 35. As is most clearly demonstrated by the views in FIGS. 5 and 6, the privacy screen 35 is of sufficient height, and extends sufficiently far from the sidewall 7b, to obstruct a line of sight between passengers in the inwardly-facing seat unit 11a of one pair, and the neighbouring outwardly-facing seat unit 11b of the neighbouring pair. However, unlike some seat units in the prior art, the privacy screen does not extend all the way along the mutual boundary between adjacent seat units 11a, 11b. Instead, in the first embodiment of the invention, the privacy screen 35 extends only part-way between the inwardly-facing seat unit 11a of one pair and the neighbouring outwardly-facing seat unit lib of the neighbouring pair, such that it leaves an opening 41 (schematically indicated by dash-dot lines in FIG. 2) through which a passenger may pass to access the inwardly-facing seat unit 11b. Embodiments of the invention recognise that a sense of privacy and personal space may be obtained by screening the line of sight between two seat units, whilst not necessarily fully enclosing one side of one of those seat unit. This thus allows access to both seat units 11a, 11b via the shared entrance way 39, whilst maintaining privacy.

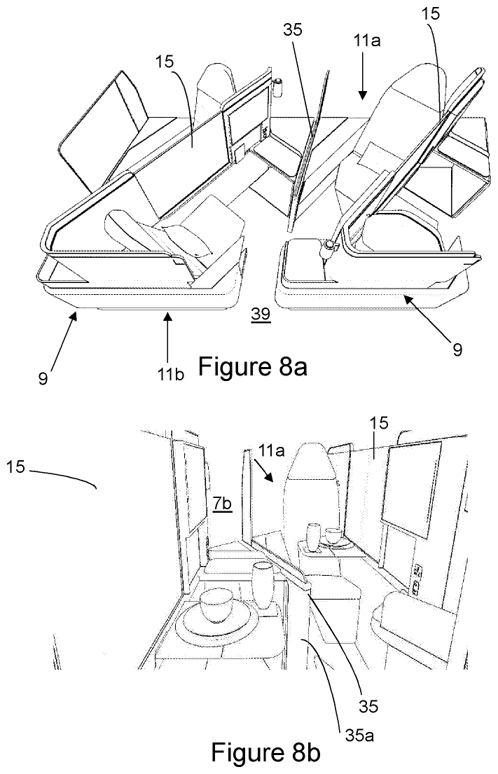

Referring now to FIGS. 8a and 8b, embodiments of the present invention also allow passengers in the inwardly-facing seat unit 11a of one pair, and the neighbouring outwardly-facing seat unit 11b of another pair, to selectively interact if and when they would like to. Specifically, the inter-pair privacy screen 35 is operable from a raised configuration (in which it screens the line of sight) to a lowered configuration shown in FIGS. 8a and 8b. FIG. 8b is a view from the seat of a passenger in the outwardly-facing seat unit 11b. A portion of the privacy screen 35 has been lowered into a base unit 35a. This opens up the line of sight between the two passengers in the seat units 11a, 11b and may be desirable when the two passengers are travelling together. Part of the intra-pair screen 15 also houses a fold-out monitor 43, which (when deployed—see FIG. 7) may also assist with a feeling of privacy.

Referring back to FIGS. 1 to 6, within each pair 9 of seat unit 11a, 11b, is an intra-pair privacy screen 15, screening the passengers of adjacent inwardly- and outward-facing seat units, within each pair 9, from one another. Referring now to FIG. 7, embodiments of the present invention allow passengers in the inwardly- and outwardly-facing seat units 11a, 11b of each pair, to selectively interact if and when they would like to. FIG. 7 shows the intra-pair screen 15 in the right hand pair 9 of seat units, in a lowered configuration in which a portion of the privacy screen 15 has been lowered into a base unit 15a. This opens up the line of sight between the two passengers in the seat units 11a, 11b in that pair, and may be desirable when the two passengers are travelling together.

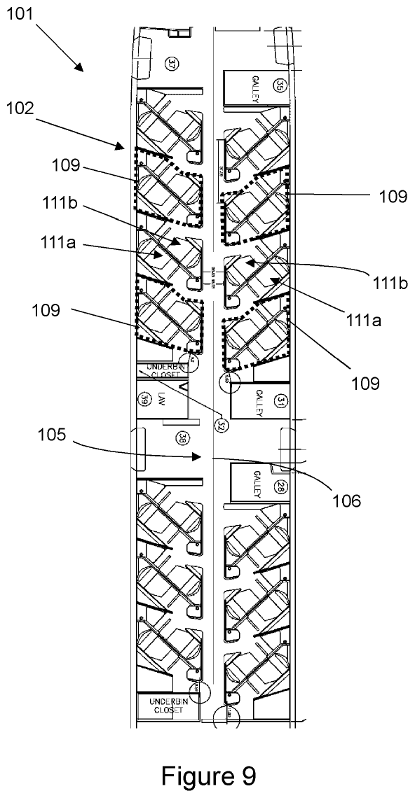

FIG. 9 shows a cabin 102 according to a second embodiment of the invention. Features in the second embodiment of the invention that correspond to similar features in the first embodiment of the invention, are shown with the same reference numerals as in the first embodiment, but with the addition of the prefix ‘1’ (or ‘10’ where appropriate). The second embodiment is the same as the first embodiment except that the fore/aft orientation of the seat units 111a, 111b is swapped. In other words, the outwardly-facing seat units face 111b forwards, whereas the inwardly-facing seat units 111a face backwards.

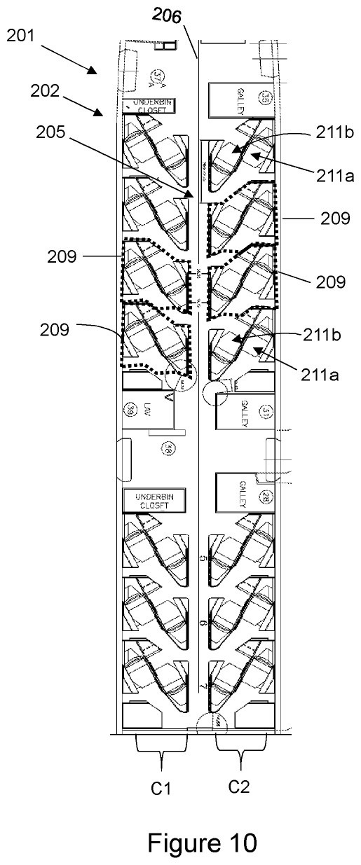

FIG. 10 shows a cabin 202 according to a third embodiment of the invention. Features in the second embodiment of the invention that correspond to similar features in the first embodiment of the invention, are shown with the same reference numerals as in the first embodiment, but with the addition of the prefix ‘2’ (or ‘20’ where appropriate).

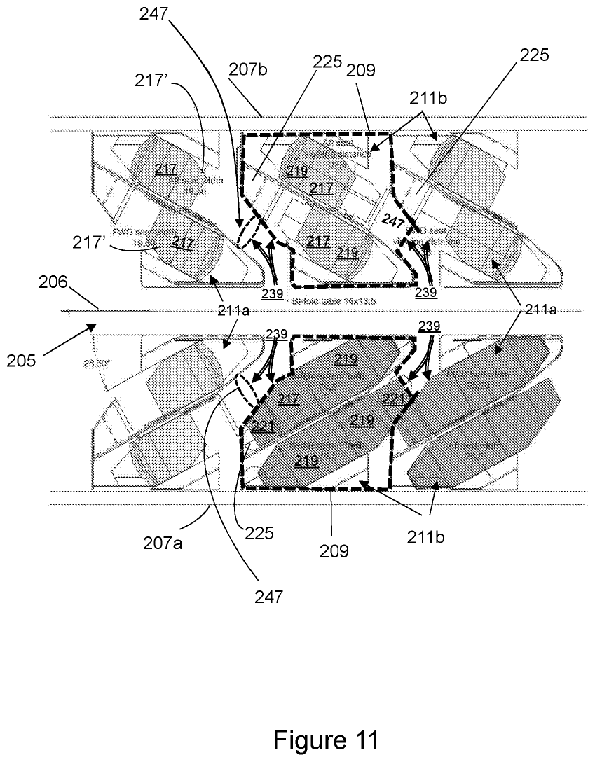

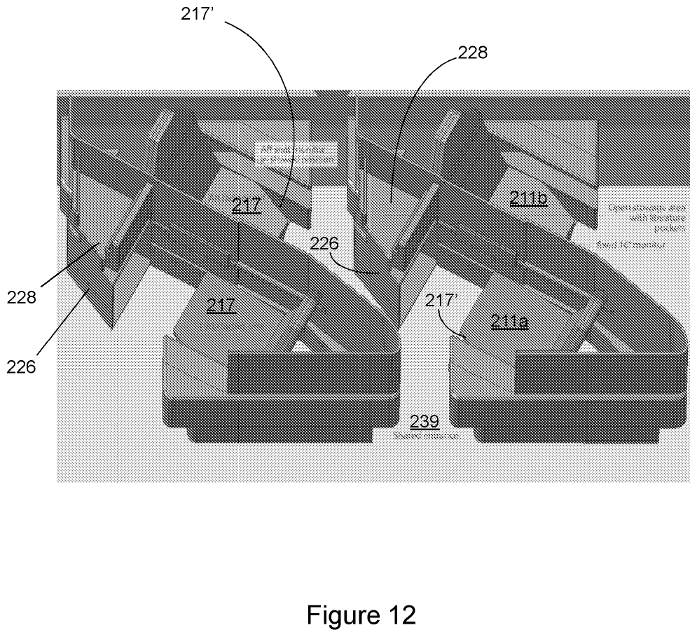

FIG. 11 shows a close up view of six pairs 209 of seat units in the cabin 202. The upper seat units (in column C2 of FIG. 10) are in the seating configuration, whereas two of the pairs of lower seat units (in column C1 of FIG. 10) are shown in the flat bed configuration.

As in the first and second embodiments, the seating arrangement 201 comprises a multiplicity of pairs 209 of seat units arranged consecutively along the longitudinal direction. Each pair 209 comprises an inwardly-facing seat unit 211a facing towards the aisle 205, and an adjacent outwardly-facing seat unit 211b facing away from the aisle 205.

Unlike the earlier embodiments, the seat units 211a, 211b are all orientated at a lower angle to the longitudinal axis 206, namely 28.5 degrees. The inwardly-facing seat units 211a are also set back from the aisle 205 such that the shared entrance way 239 is defined between the shroud and side furniture of the outwardly-facing seat units 211b of adjacent pairs 209.

An obstacle free access path, shown with large arrows in FIG. 11, extends from the shared entrance way 239 to the seat units 211a, 211b, and is useable by a passenger to access each of those seat units 211a, 211b without impinging on the other of the seat units 211b, 211a.

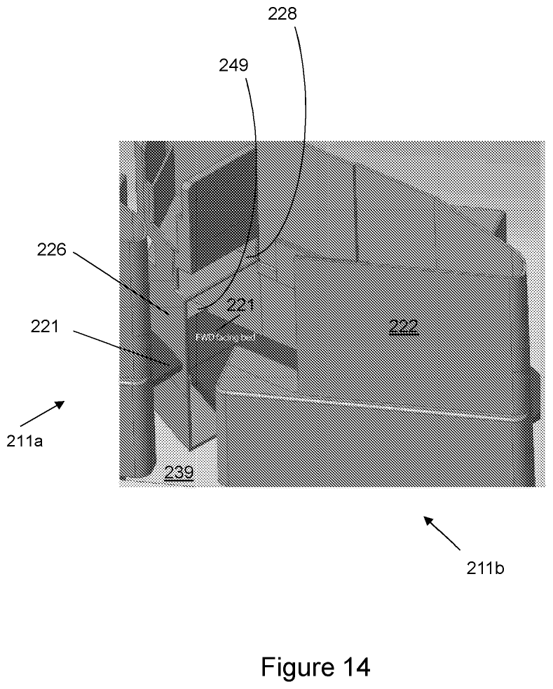

The foot receiving end 225 of the outwardly-facing seat units 211b comprises an enclosed ottoman having an end wall 226, and internal shelf 249 (visible in FIG. 14), and an upper table surface 228. When the outwardly-facing seat units are in the flat bed configuration, the seat back 219 lies flat and the leg rest 221 extends to the ottoman to create a useable flat sleeping surface (of 74.5 inches), extending from the foot receiving to the head receiving ends of the seat unit (for example see the lower pairs in FIG. 11).

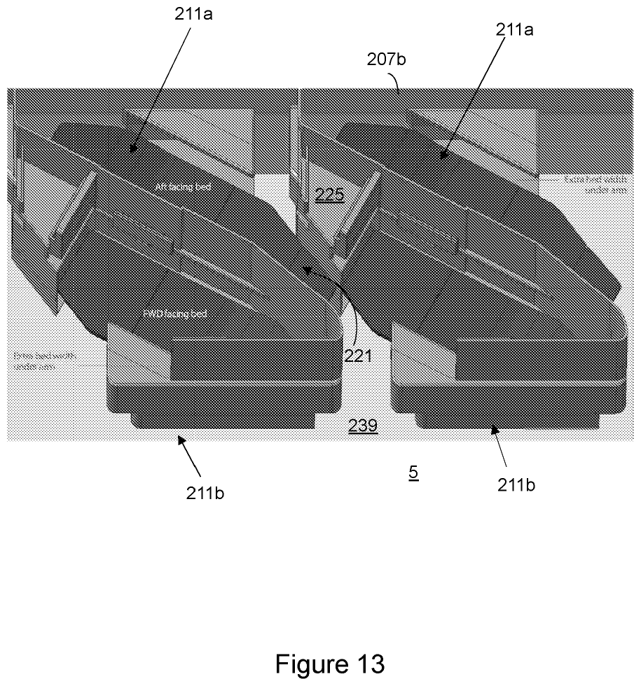

In contrast, the inwardly-facing seat units 211a in contrast are open-ended. In the flat bed configuration, a moveable seating element (namely the leg rest 221) extends to the foot receiving end of the seat unit (see lower pairs in FIGS. 11 and 13). However, when an inwardly-facing seat unit 211b is in the seating configuration, the moveable seating elements form a seat such that the leg rest 221 is retracted. Since the seat unit is open ended, this reveals an access space 247 (shown by a dotted oblong in FIG. 11) between the sides of the respective foot and head receiving ends of the neighbouring outwardly-facing seat units 211b. The access space 247 is sized such that a passenger may pass through, in order to access the inwardly-facing seat unit 211a. The access to the inwardly-facing seat unit when the seat unit is placed into the seating configuration can be envisaged by considering the retraction of the leg rest 221 of the inwardly-facing seat unit 211a shown on the left-hand side of FIG. 14.

Thus, in the second embodiment of the invention, access to two seat units 211a, 221b is enables via a dedicated, shared, entrance 239. Furthermore, by not using a fixed structure (such as an ottoman or end wall) at the end of the inwardly-facing seat units, the passenger to the inwardly-facing seat unit is provided with obstacle free access to their seat unit, despite it being set back from the aisle 205.

The seat pans 217 of all the seat units 211a, 22b in the second embodiment of the invention all comprise a chamfered corner 217′. The chamfered corner 217′ is on the left-hand side of all seat pans (as viewed locally to that seat unit). This means that the chamfers tend to complement each other when the seat pans are in the flat bed configuration—specifically the tapering, narrow, side of the bed of one seat unit 211a is adjacent the tapering, narrow side, of the neighbouring seat unit 211b with which it shares access via the entrance way 239. This is best illustrated in FIG. 11 for example. The description above is with reference to the seat units in column C2; in the opposing column C1, the chamfers are on the other side.

The chamfer 217′ on the seat pan 217 of the outwardly-facing seat unit 211b also facilitates a relatively wide access path from the shared entrance way 239, especially as a passenger approaches the access opening 247 of the inwardly-facing seat unit 211a (see FIG. 13 for example).

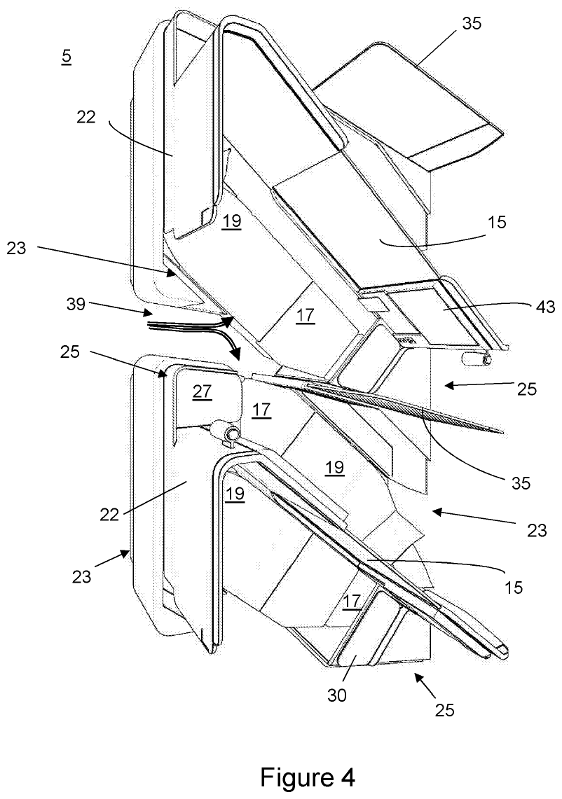

Referring back to the first and second embodiments, the chamfer 17′ of the inwardly-facing seat units is also beneficial in facilitating a relatively wide access path from the shared entrance way 39, especially in creating a relatively open area for a passenger to stand between the two seat units access by the entrance 39 (illustrated in FIG. 4 for example).

According to another embodiment of the invention (not shown) the passenger seating assembly is provided on a twin aisle aircraft. The arrangement comprise three parallel columns of pairs of seat units. Two columns are substantially as described herein with reference to the first embodiment, except that column C2 is adjacent a second aisle instead of the sidewall 7b. The other side of that aisle is another column, substantially identical to C2, but adjacent the sidewall. In another twin-aisle arrangement the central column is double-width and is symmetrical along the longitudinal axis of the aircraft.

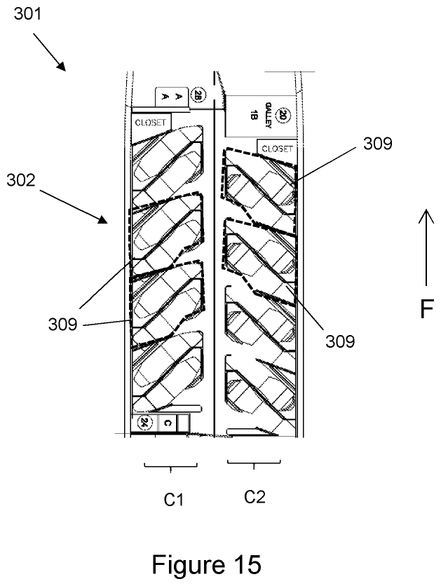

A further embodiment of the invention is shown in FIGS. 15 to 20b. Features in this further embodiment of the invention that correspond to similar features in the first embodiment of the invention, are shown with the same reference numerals as in the first embodiment, but with the addition of the prefix ‘3’ (or ‘30’ where appropriate). This further embodiment is broadly the same as the first embodiment except for the differences described below.

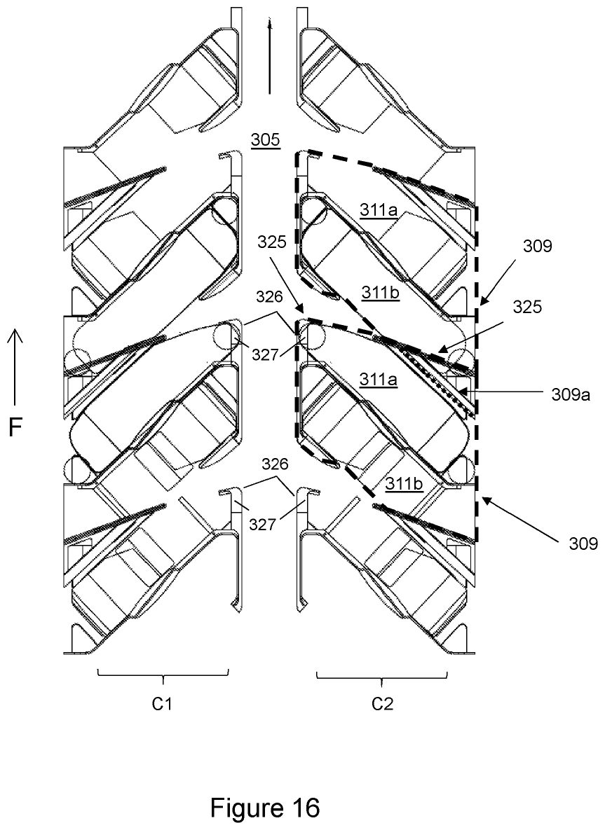

FIG. 15 shows the seating layout 301 in the front of an aircraft cabin 302 according to the further embodiment. All the seat units in the left hand column C1 are shown in a flat-bed configuration, and all those on the right hand column C2 are shown in a seating configuration. The seat units are arranged in pairs 309, denoted by the dashed lines in FIG. 15. FIG. 16 shows a close up view of part of this layout, and in which the seat units are shown in a different mixture of seat and flat-bed configurations. The circles at each end of some of the seat units indicates the useable lengths of the seat units; it will be appreciated that these do not represent physical structures.

Referring now to FIG. 16, two adjacent pairs 309 in column C2 are shown outlined in a dashed line. In contrast to the first embodiment, each outwardly-facing seat unit 311b underlaps the inwardly-facing seat unit 311a of the neighbouring pair in an underlap region 309a. This facilitates a relatively wide foot receiving end 325 to be created for the outwardly-facing seat unit 311b, whilst still providing a side surface to the side of the inwardly-facing seat unit 311a. In this respect it will be appreciated that the dashed-outline showing the boundary of the pairs 309 in FIGS. 15 and 16 is shown in planform for the upper-most part of the boundary only (the outline of the boundary actually changing with height).

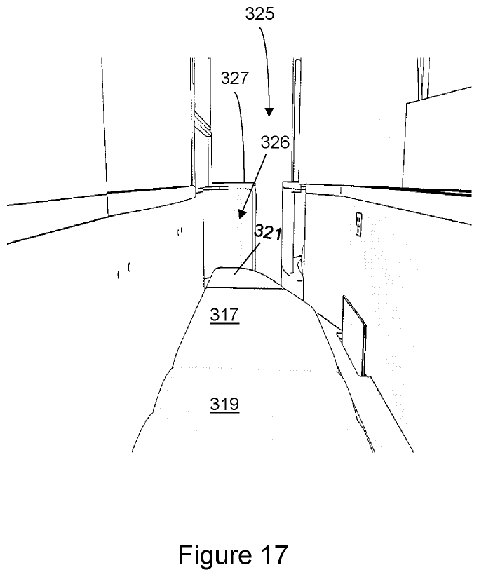

Referring to FIG. 16 and also to FIG. 17 (FIG. 17 being a view from an inwardly-facing seat unit 311a when it is in the flat-bed configuration), the inwardly-facing seat units 311a do not, in contrast to the first embodiment, include an ottoman. Instead, the foot receiving end 325 of these inward facing units only comprise an end wall 326 structure that partitions the passenger from the aisle 305. The wall 326 does not include an internal shelf, and instead the leg rest 321 on the seat units 311a is configured to extend towards and up to the wall 326 to create the bed surface. By not having an internal shelf (i.e. not having an ottoman), the passenger experience is more closely matched to that of a passenger in an outwardly-facing seat unit 311b (which is similar to that in the first embodiment and also does not include an ottoman).

A narrow utility surface 327 extends from the top of the wall 326 at the foot receiving end 325, but does not protrude as far as the table top 27 in the first embodiment. This is beneficial in terms of ensuring straightforward access/egress to the inward facing seat unit 311a.

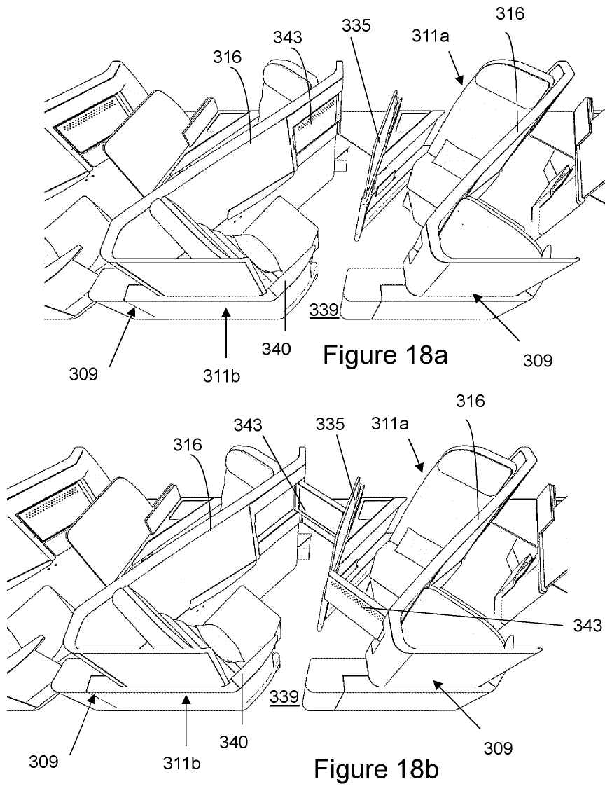

Some other differences from the first embodiment are shown in FIGS. 18a and 18b. These are perspective views of two neighbouring pairs of seat units 309. Firstly, the monitor 343 is pivoted along the edge furthest from the passenger (rather than closest to the passenger as per the first embodiment—see FIG. 7). This has been found to be beneficial because it creates the feeling of a relatively large suite, whilst also acting to maintain privacy and separation between passengers in the neighbouring seat units 311a, 311b of neighbouring pairs 309 (the monitor 343 now spanning most of the width of the seat unit when deployed).

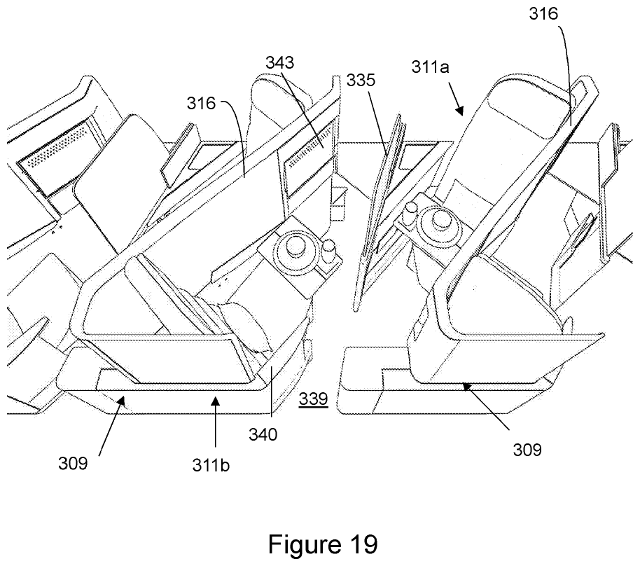

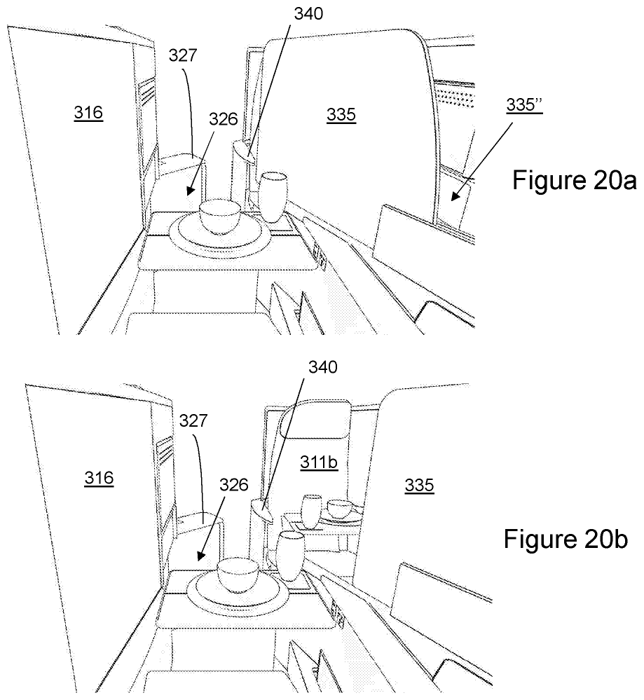

Secondly, it can be seen that there is no moveable intra-pair screen in this embodiment. Instead, a solid and fixed screen 316 extends between the inward and outwardly-facing seat units 311a/311b in each pair of units 309. There is still the ability to create a shared space between neighbouring seat units of neighbouring pairs via the inter-pair screen 335 and this is now described in more detail with reference to FIGS. 19, 20a and 20b.

FIG. 19 shows a perspective view in which the inwardly-facing seat unit 311a of one pair and the outwardly-facing seat unit 311b of the neighbouring pair are ready for dining (i.e. tables deployed and laid for eating). A perspective view from the view point of the inwardly-facing seat unit 311a is shown in FIG. 20a. In this case the inter-pair screen 335 is deployed in a forwards position and creates a private environment. There is a space 335″ between the screen 335 and the sidewall of the cabin but this does not significantly impact on privacy because it is not within line of sight of the neighbouring passenger. As shown in FIG. 20b, to create a shared environment, the screen 335 slides back towards the sidewall and into this space 335″. The passengers in respective inwardly and outwardly facing seat units can then readily interact when wanted but can readily switch back to a private environment at other times.

Finally, as shown in FIGS. 18a and 18b, the outwardly-facing seat units 311b of this embodiment comprise a moveable armrest 340 that may be raised or lowered. When it is in the lowered position, the moveable armrest facilitates access/egress into the seat unit (which passengers access via the shared entrance way 339).

Whilst the present invention has been described and illustrated with reference to particular embodiments, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A passenger seating arrangement in an aircraft cabin, the passenger seating arrangement comprising a column of seat units located adjacent an aisle, the column of seat units and the aisle both extending in a longitudinal direction parallel to the longitudinal axis of the aircraft cabin, wherein:
the column comprises a multiplicity of pairs of seat units arranged consecutively along the longitudinal direction, each pair of seat units comprising an inwardly-facing seat unit and an adjacent outwardly-facing seat unit, the inwardly-facing seat unit being angled at an acute angle to the longitudinal axis of the aircraft and facing inwardly towards the aisle, and the outwardly-facing seat unit being angled at an acute angle to the longitudinal axis of the aircraft but facing outwardly away from the aisle,
wherein each seat unit is configurable between a seating configuration and a flat-bed configuration, and
wherein the passenger seating arrangement further comprises a plurality of entrance ways, each entrance way being located between a neighbouring pair of seat units, and each entrance way being a shared entrance way to provide access from the aisle to two seat units, the two seat units being an inwardly-facing seat unit of one pair and the neighbouring outwardly-facing seat unit of the neighbouring pair.

2. A passenger seating arrangement according to claim 1, wherein each seat unit comprises a seat body, the seat body comprising moveable seating elements arranged such that when the seat unit is in the seating configuration the seating elements form a passenger seat but when the seat unit is in the flat-bed configuration, the seating elements form a substantially flat sleeping surface.

3. A passenger seating arrangement according to claim 1, wherein an inter-pair privacy screen is positioned between neighbouring pairs of seat units, the inter-pair privacy screen extending only part-way between the inwardly-facing seat unit of one pair and the neighbouring outwardly-facing seat unit of the neighbouring pair, thereby leaving an opening through which a passenger may pass to access one of said seat units.

4. A passenger seating arrangement according to claim 3, wherein the inter-pair privacy screen is configured to screen a line of sight between passengers seated in the inwardly-facing seat unit of the one pair and the neighbouring outwardly-facing seat unit of the neighbouring pair.

5. A passenger seating arrangement according to claim 3, wherein the inter-pair privacy screen extends in a direction away from the sidewall of the aircraft.

6. A passenger seating arrangement according to claim 3, wherein the inter-pair privacy screen is configurable between a deployed configuration for maintaining privacy between passengers seated in the inwardly-facing seat unit of the one pair and the neighbouring outwardly-facing seat unit of the neighbouring pair, and a stowed configuration for enabling those passengers to interact.

7. A passenger seating arrangement according to claim 3, wherein the acute angle is in a range between 35 and 50 degrees.

8. A passenger seating arrangement according to claim 3, wherein each inwardly-facing seat unit has a foot receiving end configured to receive a passenger's feet when the inwardly-facing seat unit is in the flat-bed configuration, and wherein the foot receiving end comprises a wall defining a partially enclosed space for receiving the passenger's feet.

9. A passenger seating arrangement according to claim 8, wherein each outwardly-facing seat unit has a foot receiving end, the foot receiving end being configured to receive a passenger's feet when the outwardly-facing seat unit is in the flat-bed configuration,
and wherein the planform shape of the foot receiving end of the outwardly-facing seat unit is different to the planform shape of the foot receiving end of the inwardly-facing seat unit.

10. A passenger seating arrangement according to claim 8, wherein each outwardly-facing seat unit comprises a head-receiving end for receiving a passenger's head, and wherein the head receiving end adjoins the foot receiving end of the inwardly-facing seat unit in the respective pair of seat units.

11. A passenger seating arrangement according to claim 8, wherein the shared entrance way is defined between part of an outwardly-facing seat unit of one pair of seat units, and the foot receiving end of the neighbouring inwardly-facing seat unit of the neighbouring pair of seat units.

12. A passenger seating arrangement according to claim 2, wherein each inwardly-facing seat unit is arranged such that when the inwardly-facing seat unit is in the flat-bed configuration, a moveable seating element extends to the foot receiving end of the seat unit,
and wherein the inwardly-facing seat unit is open-ended such that when it is in the seating configuration, the moveable seating element is retracted such that there is an access space through which a passenger may pass to access the inwardly-facing seat unit.

13. A passenger seating arrangement according to claim 12, wherein the access space is accessible from the aisle via the shared entrance way.

14. A passenger seating arrangement according to claim 12, wherein the acute angle is in a range between 25 and 35 degrees.

15. A passenger seating arrangement according to claim 12, wherein the inwardly-facing seat unit is set back from the aisle.

16. A passenger seating arrangement according to claim 15, wherein the foot receiving end of the inwardly-facing seat unit is located between the outwardly-facing seat unit in the respective pair of seat units, and the outwardly-facing seat unit of the neighbouring pair.

17. A passenger seating arrangement according to claim 12, wherein the shared entrance way is defined between the outwardly-facing seat units in neighbouring pairs of seat units.

18. A passenger seating arrangement according to claim 2, wherein the moveable seating elements comprise a seat pan, and the seat pan of each seat unit comprises a chamfered corner adjacent an access path through the shared entrance way.

19. A passenger seating arrangement according to claim 18, wherein the chamfered corner is on the same side of each seat pan, as viewed from each respective seat pan.

20. A passenger seating arrangement according to claim 1, wherein the inwardly and outwardly-facing seat units in each pair of seat units, border each other along a shared boundary.

21. A passenger seating arrangement according to claim 20, each pair of seat units comprises an intra-pair privacy screen along the shared boundary, for screening the two seat units within each pair, from each other.

22. A passenger seating arrangement according to claim 1, wherein the seating arrangement further comprise a second column of seat units located on the other side of, but adjacent to, the aisle, the second column of seat units also extending in a longitudinal direction parallel to the longitudinal axis of the aircraft cabin, and wherein
the second column comprises a multiplicity of pairs of seat units arranged consecutively along the longitudinal direction, each pair of seat units comprising an inwardly-facing seat unit and an adjacent outwardly-facing seat unit, the inwardly-facing seat unit being angled at the acute angle to the longitudinal axis of the aircraft and facing inwardly towards the aisle, and the outwardly-facing seat unit being angled at the acute angle to the longitudinal axis of the aircraft but facing outwardly away from the aisle,
wherein each seat unit is configurable between a seating configuration and a flat-bed configuration, and
wherein the passenger seating arrangement further comprises a plurality of entrance ways, each entrance way being located between a neighbouring pair of seat units, and each entrance way being a shared entrance way to provide access from the aisle to two seat units, the two seat units being an inwardly-facing seat unit of one pair and the neighbouring outwardly-facing seat unit of the neighbouring pair.

23. A passenger seating arrangement according to claim 22, wherein the first column is positioned adjacent a sidewall of the cabin and second column is positioned adjacent the opposing sidewall of the cabin.

24. A passenger seating arrangement according to claim 22, wherein the first column is positioned adjacent a sidewall of the cabin, the second column is positioned adjacent a second aisle, and the arrangement further comprises a third column of pairs of seat units between the opposing sidewall and the second aisle.

25. A passenger seating arrangement in a single aisle aircraft cabin, the passenger seating arrangement comprising a first column of lie-flat seat units located on one side of the single aisle, and a second column of lie-flat seat units located on the other side of the aisle, wherein:
each column comprises a multiplicity of seat units arranged in an alternately-facing herringbone layout in which alternate seat units face inwardly and outwardly towards/away from the aisle,
wherein the passenger seating arrangement further comprises a plurality of shared entrance ways, each shared entrance way having obstacle-free access from the aisle to two seat units in a respective column.

26. A passenger seating arrangement according to claim 25, wherein all the outwardly-facing seat units border the aisle and all the inwardly-facing seat units are set back from the aisle,
and wherein the inwardly-facing seat units do not have an ottoman such that they are open-ended to allow access to the inwardly-facing seat units from the shared entrance way.

27. A pair of seat units for use in the passenger seating arrangement of claim 1, the pair of seat units being configured to be arranged consecutively, with other corresponding pairs of seat units, in a column along a longitudinal direction, the pair of seat units comprising an inwardly-facing seat unit and an adjacent outwardly-facing seat unit, the inwardly-facing seat unit being angled at an acute angle to the longitudinal direction and facing inwardly, and the outwardly-facing seat unit being angled at an acute angle to the longitudinal direction but facing outwardly, in the opposite direction to the inwardly-facing seat unit,
wherein each seat unit is configurable between a seating configuration and a flat-bed configuration, and
wherein the pair of seats units is configured to be arranged with an entrance way located between it and a neighbouring pair of seat units, the entrance way being a shared entrance way to provide access from the aisle to two seat units, the two seat units being an inwardly-facing seat unit of one pair and the neighbouring outwardly-facing seat unit of the neighbouring pair.
